(19) United States
(12) Patent Application Publication
(10) Pub. No.: US 2004/0187097 A1
(43) Pub. Date: Sep. 23, 2004

(54) Method for parameterizing software process signal connections of a drive unit

(75) Inventors: Ulrich Boelkens, Numberg (DE); Gerhard Heinemann, Erlangen (DE); Eckart Krebber, Erlangen (DE); Till-Christian Siering, Forchheim (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/764,983

(22) Filed: Jan. 26, 2004

(30) Foreign Application Priority Data
Jan. 24, 2003 (DE) 103 02 799.8

(51) Int. Cl. G06F 9/44

(52) U.S. Cl. 717/120; 717/104

(57) ABSTRACT

A method for parameterizing software process signal connections between control modules and/or input/output modules of a drive unit is disclosed. Each module has at least one connector of a type designated as signal source and/or signal sink. For connecting a process signal between a signal source and a signal sink, a parameter number of an associated signal source identification parameter is entered as a connection parameter of a corresponding signal sink, and optionally also an index number of the signal source. The disclosed method facilitates the parameterization of software process signal connections between control modules and/or input/output modules of a drive unit.

### CROSS-REFERENCES TO RELATED APPLICATIONS

This application claims the priority of German Patent Application, Serial No. 103 02 799.8, filed Jan. 24, 2003, pursuant to 35 U.S.C. 119(a)-(d), the disclosure of which is incorporated herein by reference.

### BACKGROUND OF THE INVENTION

The present invention relates to a method for parameterizing software process signal connections between control modules and/or input/output modules of a drive unit.

Drive units are conventionally used for controlling and/or regulating industrial drives, in particular drives of machine tools or production machines. In the application, the term “production machine” is used here in a generic sense and includes also robots which generally follow the concepts outlined here. A dedicated drive unit providing control functionality is typically associated with each drive, wherein the drive can include, for example, a motor, a load and/or a gear.

A conventional drive unit typically includes a single control module, an electric input/output interface and an electric power controller for controlling and/or powering the drive motor. The control module is typically implemented as a software module on a microprocessor system. A supervisory controller supplies to the drive, for example, a desired rotation speed value unit via an electric input interface connected with the drive unit. Inside the drive unit, the desired rotation speed value is then supplied to the control module which controls the rotation speed of the motor commensurate with the desired rotation speed value. The drive unit receives an actual motor rotation speed at another input terminal of the input interface.

In many applications, process data must be exchanged between the different drives of the machine. Examples are master/slave drives, gantry drives and redundant drive systems. The process data need to be exchanged reliably and fast, i.e. in real-time, since data transmission speed determines the control characteristic and the operating reliability of the machine. As mentioned above, only a single drive unit has hitherto been associated with each drive, while the corresponding process data are exchanged between one or more drive units via electrical connections. The process data exchange between drive units is accomplished today as follows:

The drive units exchange process data via a hardwired point-to-point electrical connection, which transmits digital or analog signals and has to be configured by the user for each system or system type.

The drive units exchange process data via a digital fieldbus. The communication can occur either indirectly via a master fieldbus partner (e.g., a supervisory controller) or directly between the drive units. Accordingly, a supervisory fieldbus communication must be designed and/or programmed in addition to the corresponding parameterization of the individual drive units.

Modern microprocessor systems are powerful enough to accommodate several control modules within a single drive unit that perform simultaneous computations in real-time.

Due to the many different requirements imposed by the applications, the exchange of process data between the individual modules within such a very powerful drive unit requires software that can flexibly set up software process signal connections between the individual modules (e.g. between two control modules).

It would therefore be desirable and advantageous to provide an improved system and method for parameterizing software process signal connections between control modules and/or input/output modules of a drive unit, which obviates prior art shortcomings and is specifically adapted to reconfigure signal connections between various devices.

### SUMMARY OF THE INVENTION

According to one aspect of the invention, a method for parameterizing software process signal connections between control modules and/or input/output modules of a drive unit, includes the steps of assigning to each module a connector type selected from the group consisting of signal sink and signal source, assigning to each signal source a module-specific signal source identification parameter, which includes a signal ID and a parameter number, assigning to each signal sink a module-specific signal sink identification parameter and a parameterizable connection parameter, and—for connecting a process signal between a signal source and a corresponding signal sink—entering as the parameterizable connection parameter of the signal sink the parameter number of the signal source identification parameter.

According to another aspect of the method of the invention, a method for parameterizing software process signal connections between control modules and/or input/output modules of a drive unit, includes the steps of assigning to each module a connector type selected from the group consisting of signal sink and signal source, and a module-specific index number, assigning to each signal source a signal source identification parameter which includes a signal ID and a parameter number, assigning to each signal sink a signal sink identification parameter and a parameterizable connection parameter, and for connecting a process signal between a signal source and a signal sink—entering as the parameterizable connection parameter of the associated signal sink the parameter number of the associated signal source identification parameter and the index number of the signal-generating module.

According to a first advantageous embodiment of the invention, the methods can further include the step of coding the signal source identification parameter and/or the signal sink identification parameter with a letter code that indicates if the connector type represents a signal source or a signal sink. This enables a particularly simple coding and/or differentiation between a signal source and a signal sink.

According to another advantageous embodiment of the invention, the parameter number can be coded in form of a number code. In this way, an arbitrarily large number of parameters numbers can be defined.

According to another aspect of the invention, a drive unit for controlling and/or regulating drives of machine tools or production machines includes a plurality of control modules and/or input/output modules, wherein a module has a connector for connecting the module to another one of the modules. A connector type, which can be either a signal sink or a signal source, is associated with each a connector. The drive unit further includes a connection capable transmitting a process signal between a signal source and a signal sink. Each signal source has a module-specific signal source identification parameter, which includes a signal ID and a parameter number, and each signal sink has a module-specific signal sink identification parameter and a parameterizable connection parameter. The parameterizable connection parameter of the signal sink includes the parameter number of the signal source identification parameter.

Alternatively, a module includes a module-specific index number, and the parameterizable connection parameter of the associated signal sink includes the parameter number of the associated signal source identification parameter and the index number of the signal-generating module.

The method is particularly suited for parameterizing software process signal connections between control modules and/or input/output modules of a drive unit that controls and/or regulates drives of machine tools or production machines, since such machines frequently employ several drives.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic block diagram of a drive unit according to the invention;

FIG. 2 is a schematic block diagram of a drive unit according to the invention, wherein the modules have additional index numbers; and

FIG. 3 is a high-level block diagram of a drive unit according to the invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

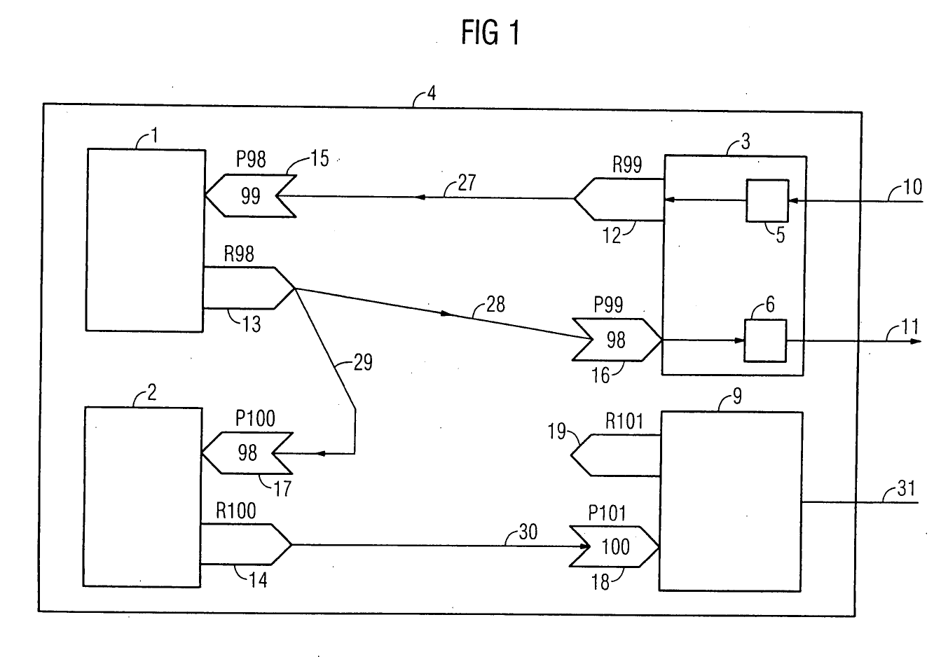

Turning now to the drawing, and in particular to FIG. 1, there is shown a block circuit diagram of a drive unit 4 according to the present invention. The drive unit 4 includes a microprocessor system (not shown) as well as two input/output modules 3 and 9. The microprocessor system performs simultaneous computations for the two control modules 1 and 2, which are implemented on the microprocessor system in the form of software modules. An analog/digital converter 5 and a digital/analog converter 6 are disposed in the input/output module 3. Each module 1, 2, 3 and 9 has two different connector types for parameterizing the software process signal connections 27, 28, 29 and 30, which connect the corresponding modules 1, 2, 3 and 9, respectively, of the drive unit 4. A signal-generating connector type is hereafter referred to as signal source, whereas a signal-receiving connector type is referred to as a signal sink. In the embodiment depicted in FIG. 1, the signal sink 15 and the signal source 13 are assigned to the control module 1, whereas the signal sink 17 and the signal source 14 are assigned to the control module 2. The signal source 12 and the signal sink 16 are assigned to the input/output module 3, and the signal source 19 and the signal sink 18 are assigned to the input/output module 9. For sake of clarity of the drawing, only one signal source and one signal sink are shown as being associated with each module. However, it will be understood that a module can in principle have any number of signal sinks and/or signal sources.

Each signal source has a module-specific signal source identification parameter, and each signal sink has a signal sink identification parameter, all implemented in software. The signal source 12 is identified by the signal source identification parameter R99, the signal source 13 by the signal source identification parameter R98, the signal source 14 by the signal source identification parameter R100, and the signal source 19 by the signal source identification parameter R101.

The signal sink 15 is identified by the signal sink identification parameter P98, the signal sink 16 by the signal sink identification parameter P99, the signal sink 17 by the signal sink identification parameter P100, and the signal sink 18 by the signal sink identification parameter 101.

Each signal source identification parameter is composed of a signal designator and a parameter number. The signal source identification parameter R99 of the signal source 12 is composed, for example, of the signal designator R and the parameter number 99, as shown in FIG. 1. Likewise, the other signal sink identification parameters are each composed of a signal designator and a parameter, as also shown in FIG. 1.

The signal designators are shown as being coded by a letter, whereas the parameter number is coded as a numerical value. The signal source in the described embodiment is identified by the letter R, whereas a signal sink is identified by the letter P as the signal designator. In a situation where a module has several signal sinks, additional positions can be coded in the parameter number. It will be understood that the signal source identification parameter and/or the signal sink identification parameter can also be coded as a purely numerical code. However, this can make parameterization of software process signal connections less transparent, which may be viewed as a disadvantage. It is also be understood that other letters in addition to or instead of R and P can be used for coding the signal designator, as well as a combination of such letters.

A parameterizable connection parameter is assigned to each signal sink 15, 16, 17 and 18 for parameterizing the software process signal connections 27, 28, 29 and 30. The software process signal connections 27, 28, 29 and 30 between a signal source and an associated signal sink can be connected by parameterizing the parameter number of the assigned signal source identification parameter as a connection parameter of the associated signal sink.

For example, the A/D (analog-to-digital) converter 5 in the input/output module 3 digitizes, for example, an electric input signal 10 (for example an actual controlled variable or a setpoint signal received from a supervisory controller), with the digitized output signal in the software implementation being available at the signal source 12. In the exemplary embodiment of FIG. 1, the software process signal connection 27 must be parameterized for transmitting the digitized output signal to the control module 1. For this purpose, the parameter number of the associated signal source identification parameter of the signal source 12 is entered as a connection parameter of the signal sink 15. In the illustrated embodiment, this is represented by the number 99.

According to the embodiment in FIG. 1, the software process signal connections 28, 29 and 30 can be parameterized in this manner. As also shown in FIG. 1, several signal sinks 17, 16 can be assigned to a signal source 13. The D/A (digital-to-analog) converter 6 can hereby transform a process signal from the control module 1 into an electric output signal 11 that controls, for example, an external power controller.

It is known in the art to connect machine components, such as a drive units, power controllers and motors, with each other via a data network, for example, through a physical point-to-point connection in form of a physical Ethernet connection 31 or another equivalent connection.

For example, the software process signal connections 30 can be connected by the Ethernet connection 31, implemented for example in the form of an Ethernet interface, directly via the input/output module 9 to external machine components, such as a power controllers and/or optionally also another drive unit and/or an external input/output module and/or a supervisory controller, for exchanging process data.

The same parameterization method of the invention can be used to transmit data from the external machine components to the drive unit 4. These data could be available, for example, at the signal source 19, and transmitted to the control modules 1 and 2. The control modules 1 and 2 can include an additional signal sink (not shown in FIG. 1 for sake of clarity), which can be used for convenient parameterization and/or set up of any additionally required software process signal connections.

Since the connection parameters of the corresponding signal sink can be freely parameterized at any time, the software process signal connections in the drive unit can always be easily changed or adapted to the various requirements of the applications. The software process signal connections can be modified while the machine is operating. If the number of connection parameters is large, the software process signal connections can also be changed by simultaneously and consistently switching a parameter set.

Of course, the input/output modules can also be implemented as bus interfaces, for example, for communicating with a supervisory controller via a bus system. In a system with a modular configuration, the input/output modules can be easily exchanged in the drive unit 4. Alternatively, the input/output modules can also be integrated directly with the drive unit 4.

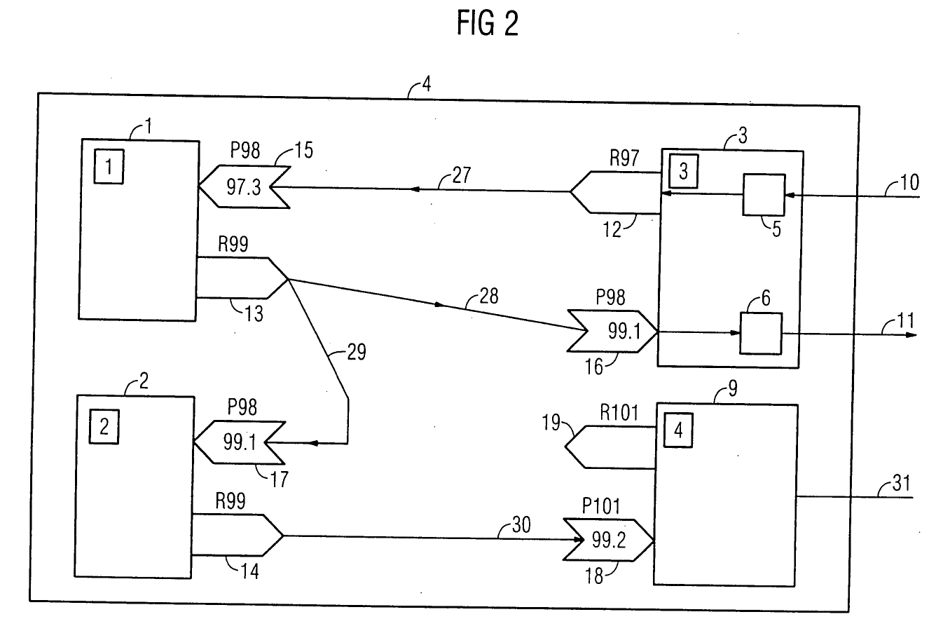

FIG. 2 shows in the form of a block circuit diagram a second embodiment of the method of the invention.

FIG. 2 essentially corresponds to FIG. 1, except for the fact that in the exemplary embodiment of FIG. 2 each module 1, 2, 3 and 9 includes an index number depicted in the upper left corner of a corresponding module. The control module 1 has, for example, the index number 1. The control module 2 can have the index number 2, the input/output module 3 the index number 3, and the input output/module 9 the index number 4. Unlike the embodiment of FIG. 1, the index number forms here a part of the connection parameter. The software process signal connections between the modules can be parameterized by entering as a connection parameter of a signal sink the parameter number of the associated signal source identification parameter, and the index number of the signal-generating module. In the embodiment illustrated in FIG. 2, the index number is separated from the parameter number of the signal source by a period.

For example, for establishing the software process signal connection 27, the number 97.3 is entered as the connection parameter, whereby the number 97 represents the parameter number of the signal source 12 and the index number 3 represents the index number of the input/output module 3. This alternative addressing option, which is used throughout FIG. 2 to label the connections, allows multiple use of the same signal source identification parameter as well as signal sink identification parameter. However, signal sinks and signal sources can still be uniquely associated due to their different module-specific index numbers.

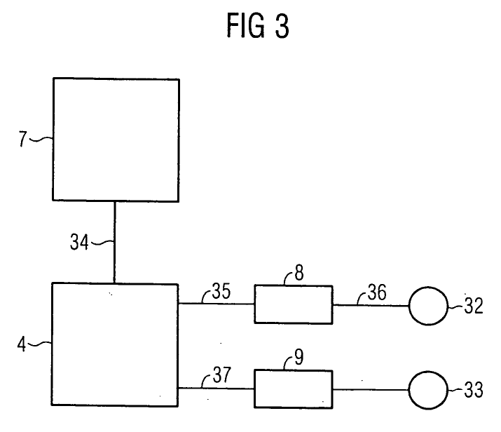

FIG. 3 shows in the form of a schematic block circuit diagram the drive unit 4 which is connected via an Ethernet connection or via another connection 34 through a bus system with a supervisory controller 7 for exchange of process data. In addition, the drive unit is connected via separate Ethernet connections 35 and 37, respectively, to two power controllers 8 and 9 that control the motors 32 and 33. Unlike conventional drive unit configurations, the power controllers are here located outside the drive units. For example, the supervisory controller 7 can transmit to a control module located inside the drive unit 4 via a corresponding connection a signal setpoint value for controlling the motor rotation speed of the motor 32. A transducer (not shown) disposed on the motor 32 supplies the actual rotation speed of motors 32 via the connections 36 and 35 to the drive unit that controls the motor rotations speed. The corresponding output signal of the control module is transmitted via the Ethernet connections 35 to the power controller 8 that controls the motor 36. The motor 33 is controlled by a second control module in the drive unit 4 in an essentially identical fashion.

By implementing several control modules inside a single drive unit in conjunction with the method of the invention, the following additional advantages are obtained:

No additional wiring is eliminated when connecting drive units with a sink module, such as a control module, which reduces costs and sources of errors.

If the communication is based on fieldbus protocol, then the transmission bandwidth of the fieldbus channel can be reduced. required. If fieldbus is used exclusively for connecting the drive units with each other, then the fieldbus can be entirely omitted.

The initial setup becomes less complex, because the additional fieldbus communication does not have to be programmed and/or specifically designed. The communication speed, the data transfer reliability and the quality control can be improved by eliminating the indirect data path via fieldbus.

The existing inputs and outputs of the drive units do not have to be fixedly assigned to a certain drive axle, but can be freely arranged. For example, the input can be associated with several power controllers and/or motors (e.g., when using a common enable signal). This flexibility allows optimal use of the existing hardware resources.

While the invention has been illustrated and described in connection with currently preferred embodiments shown and described in detail, it is not intended to be limited to the details shown since various modifications and structural changes may be made without departing in any way from the spirit of the present invention. For example, the terms “parameter number” and “index number” can represented by any type of designator.

The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for parameterizing software process signal connections between control modules and/or input/output modules of a drive unit, comprising the steps of:
assigning to each module a connector type selected from the group consisting of signal sink and signal source;
assigning to each signal source a module-specific signal source identification parameter, which includes a signal ID and a parameter number;
assigning to each signal sink a module-specific signal sink identification parameter and a parameterizable connection parameter; and
for connecting a process signal between a signal source and a corresponding signal sink, entering as the parameterizable connection parameter of the signal sink the parameter number of the signal source identification parameter.

2. The method according to claim 1, and further comprising the step of coding the signal source identification parameter and/or the signal sink identification parameter with a letter code that indicates if the connector type represents a signal source or a signal sink.

3. The method according to claim 1, wherein the parameter number is coded in form of a number code.

4. A method for parameterizing software process signal connections between control modules and/or input/output modules of a drive unit, comprising the steps of:
assigning to each module a connector type selected from the group consisting of signal sink and signal source, and a module-specific index number;
assigning to each signal source a signal source identification parameter which includes a signal ID and a parameter number;
assigning to each signal sink a signal sink identification parameter and a parameterizable connection parameter; and
for connecting a process signal between a signal source and a signal sink, entering as the parameterizable connection parameter of the associated signal sink the parameter number of the associated signal source identification parameter and the module-specific index number of the signal source module.

5. The method according to claim 4, and further comprising the step of coding the signal source identification parameter and/or the signal sink identification parameter with a letter code that indicates if the connector type represents a signal source or a signal sink.

6. The method according to claim 4, wherein the parameter number is coded in form of a number code.

7. A drive unit for controlling and/or regulating drives of machine tools or production machines, comprising:
a plurality of control modules and/or input/output modules, each module having a connector for connecting the module to another one of the modules, with a connector having associated therewith a connector type selected from the group consisting of signal sink and signal source; and
a physical connection capable transmitting a process signal between a signal source and a signal sink,
wherein each signal source comprises a module-specific signal source identification parameter, which includes a signal ID and a parameter number,
wherein each signal sink comprises a module-specific signal sink identification parameter and a parameterizable connection parameter, and
wherein the parameterizable connection parameter of the signal sink comprises the parameter number of the signal source identification parameter.

8. A drive unit for controlling and/or regulating drives of machine tools or production machines, comprising:
a plurality of control modules and/or input/output modules, each module having a connector for connecting the module to another one of the modules, with a connector having associated therewith a connector type selected from the group consisting of signal sink and signal source, as well as a module-specific index number; and
a physical connection capable transmitting a process signal between a signal source and a signal sink,
wherein each signal source comprises a module-specific signal source identification parameter, which includes a signal ID and a parameter number,
wherein each signal sink comprises a module-specific signal sink identification parameter and a parameterizable connection parameter, and
wherein the parameterizable connection parameter of the associated signal sink comprises the parameter number of the associated signal source identification parameter and the module-specific index number of the signal-generating module.
